(19) United States
(12) Patent Application Publication
(10) Pub. No.: US 2015/0156673 A1
(43) Pub. Date: Jun. 4, 2015

(54) WIRELESS COMMUNICATION SYSTEM, BASE STATION APPARATUS, AND WIRELESS COMMUNICATION METHOD

(71) Applicant: HITACHI, LTD., Tokyo (JP)

(72) Inventor: Mikio KUWAHARA, Tokyo (JP)

(21) Appl. No.: 14/542,758

(22) Filed: Nov. 17, 2014

(30) Foreign Application Priority Data
Dec. 4, 2013 (JP) 2013-250925

(51) Int. Cl. H04W 28/08; H04W 72/04

(52) U.S. Cl. CPC H04W 28/085; H04W 72/0486

(57) ABSTRACT

It is provided a wireless communication system, comprising: a plurality of terminal apparatus; and at least one base station apparatus, each of the plurality of terminal apparatus and the at least one base station apparatus being configured to communicate to/from each other with any one of a plurality of carriers, the at least one base station apparatus being configured to: determine which of a first terminal apparatus having a characteristic of repeatedly transmitting a signal at the same timing and a second terminal apparatus having a characteristic of transmitting a signal at a random timing different from the same timing each of the plurality of terminal apparatus is; monitor each of the plurality of carriers to which the first terminal apparatus is allocated; and allocate a plurality of the first terminal apparatus to distribute to the plurality of carriers based on a result of the monitoring.

### CLAIM OF PRIORITY

The present application claims priority from Japanese patent application JP 2013-250925 filed on Dec. 4, 2013, the content of which is hereby incorporated by reference into this application.

### BACKGROUND OF THE INVENTION

This invention relates to a wireless communication system.

As a background art of the technical field of this invention, there is known JP 2012-253622 A. In JP 2012-253622 A, there is disclosed a load balancing method in which an O&M control apparatus manages states of loads represented by CPU activity ratios of a wireless base station control apparatus and a call control apparatus, which are collected from the wireless base station control apparatus and the call control apparatus as operation management data, and when the load exceeds a preset threshold value, changes accommodation of one of wireless base stations coupled subordinately to the wireless base station control apparatus having the load exceeding the preset threshold value or one of the wireless base station control apparatus coupled subordinately to the call control apparatus having the load exceeding the preset threshold value, to another wireless base station control apparatus or another call control apparatus, respectively.

### SUMMARY OF THE INVENTION

Two kinds of terminal perform communications in a wireless communication system for accommodating a plurality of terminals. One is a terminal of a mobility type for performing communications at an arbitrary necessary time. The other is a terminal of a data post type placed in a fixed location in order to collect data by a sensor and transmit the data to a center.

A data post terminal is normally controlled by an application for performing communications on a regular basis. The application transmits data with a trigger such as a specific time or a specific cycle without concern for characteristics of the wireless communication system. When a plurality of data post terminals are placed, the plurality of data post terminals cause traffic in synchronization with one another, thereby sharply increasing uplink traffic at a specific time. Therefore, the traffic of the data post terminals causes a congestion state, and temporarily tightens wireless resources. Therefore, it is impossible to allocate a necessary wireless resource to the terminal of the mobility type requesting a normal service, which causes a transmission delay.

In recent years, development of a multi-carrier technology is in progress also for broadband communications. If the wireless resource is tightened only with a specific frequency, it is possible to distribute the load by subjecting a data post terminal to which the corresponding carrier is allocated to a handover under the initiative of a base station. However, in a case of identifying data post terminals having such a characteristic, selecting an appropriate terminal therefrom, and migrating the terminal to a different carrier, in the base station, it is impossible to identify the kind of terminal, and it is difficult to extract data post terminals that are transmitting data at the same timing, group the data post terminals, and select an appropriate terminal from within the group.

The representative one of inventions disclosed in this application is outlined as follows. There is provided a wireless communication system, comprising: a plurality of terminal apparatus; and at least one base station apparatus. Each of the plurality of terminal apparatus and the at least one base station apparatus communicates to/from each other with any one of a plurality of carriers. The at least one base station apparatus is configured to: determine which of a first terminal apparatus having a characteristic of repeatedly transmitting a signal at the same timing and a second terminal apparatus having a characteristic of transmitting a signal at a random timing different from the same timing each of the plurality of terminal apparatus is; monitor each of the plurality of carriers to which the first terminal apparatus is allocated; and allocate a plurality of the first terminal apparatus to distribute to the plurality of carriers based on a result of the monitoring.

According to the exemplary embodiment of this invention, it is possible to prevent congestion that occurs in a specific channel at a specific time. Problems, configurations, and effects other than those described above become apparent from a description of the following embodiment.

### BRIEF DESCRIPTION OF THE DRAWINGS

The present invention can be appreciated by the description which follows in conjunction with the following figures, wherein:

FIG. 1 is a diagram illustrating an example of an airport to which an airport surface communication is applied;

FIG. 2 is a diagram illustrating a channel configuration used in the airport surface communication;

FIG. 3 is a diagram illustrating an example of a temporal distribution of events that each of data post terminals transmits center data by using the wireless communication system;

FIG. 4 is a diagram illustrating an example of a temporal distribution of events that each of data post terminals being differ in distance from a base station transmits center data;

FIG. 5 is a sequence diagram illustrating general exchange of messages between the base station and a terminal according to this embodiment;

FIG. 6 is a diagram illustrating timings of a communication request issued in a case where the data post terminal and a mobility terminal coexist according to the embodiment;

FIG. 7 is a diagram illustrating timings of a communication request in a plurality of carriers according to the embodiment;

FIG. 8 is a configuration diagram illustrating the base station apparatus according to the embodiment;

FIG. 9 is a configuration diagram illustrating the terminal according to the embodiment;

FIG. 10 is a diagram illustrating a method for a check the terminals according to the embodiment;

FIG. 11 is a diagram illustrating control processing executed by a statistics processing module, an RRM and a database module according to the embodiment;

FIG. 12A and FIG. 12B are diagrams illustrating examples of information registered in the database module according to the embodiment;

FIG. 13A and FIG. 13B are diagrams illustrating a forgetting average according to the embodiment;

FIG. 14 is a diagram illustrating an example of a summation result obtained by repetitive processing of Step 12 in FIG. 11;

FIG. 15 is a diagram illustrating an example of processing performed in Step 13 in FIG. 11; and

FIG. 16 is a diagram illustrating an example of processing performed in Step 21 in FIG. 11.

### DETAILED DESCRIPTION OF THE PREFERRED EMBODIMENT

Now, a description is made of an embodiment of this invention with reference to the accompanying drawings.

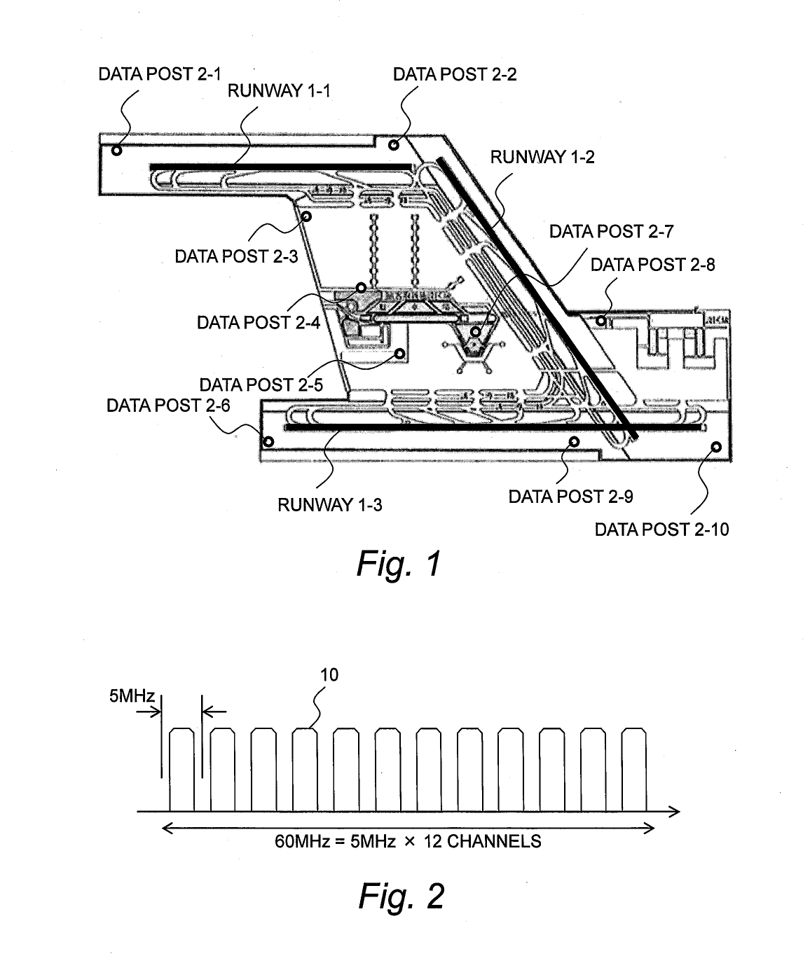

FIG. 1 is a diagram illustrating an example of an airport to which an airport surface communication is applied, and also illustrates an arrangement example of data post terminals (2-1, 2-2, . . . , 2-10) arranged within the airport.

In the illustrated example, the airport includes three runways (1-1, 1-2, and 1-3). When an aircraft makes a landing, a terminal mounted to the aircraft searches electric field strengths of a plurality of frequencies (carriers) to find a carrier having a high reception electric field strength, selects the carrier, and starts a sequence for coupling to a base station.

The airport includes a plurality of runways because the runway used for takeoff or landing and a direction of takeoff or landing are changed depending on weather conditions such as a wind direction. Further, there is a limitation to the aircraft whose takeoff or landing is allowed depending on a length of the runway. Therefore, the aircraft normally uses the same runway to repeat landing in the same direction. The runway may be changed depending on a time slot, but the landing is repeated in the same direction for a relatively long time period. As a result, most aircraft often requests to couple to a specific base station that assumes an edge of a specific runway as a coverage area, and is coupled to the base station with a specific frequency.

There are a few obstructions within the airport, which reduces attenuation of a radio wave due to the obstruction, and the radio wave easily propagates far without attenuating unlike in normal cellular communications. Further, interference is easily exerted in a distant place. Therefore, an entire system provides an environment in which use of a plurality of carriers is allowed and interference is hard to occur due to frequency division. For example, a channel configuration in which interference in the same channel is reduced with a reuse factor lowered by dividing an available bandwidth of 60 megahertz into twelve by 5 megahertz is employed. FIG. 2 illustrates the channel configuration. In FIG. 2, a channel 10 is a bandwidth (one carrier) for providing one service, and has a width of 5 megahertz. Therefore, the aircraft that has landed in the airport requests one carrier for coupling, and the service is provided by a carrier determined by negotiation with the system.

It should be noted that a description of the following embodiment is directed to a frequency division multiplex system that uses wireless resources different in frequency as carriers, but this invention can be applied to a time division multiplex system that uses wireless resources different in time as carriers. Further, a wireless communication system that uses wireless resources different in space or orthogonal code as carriers may be employed.

The terminal used on an airport surface is roughly classified into two kinds of terminal. One is the above-mentioned terminal mounted to the aircraft or a mobility terminal for communications held by ground staff. The mobility terminal performs communications at an arbitrary timing while moving. The other one is the data post terminal that is fixedly placed to couple to each of sensors for collecting information regarding flights or for monitoring which are placed in various locations within the airport. The data post terminal transmits the collected information to a center at a fixed time or on a regular basis in accordance with an instruction issued by an application.

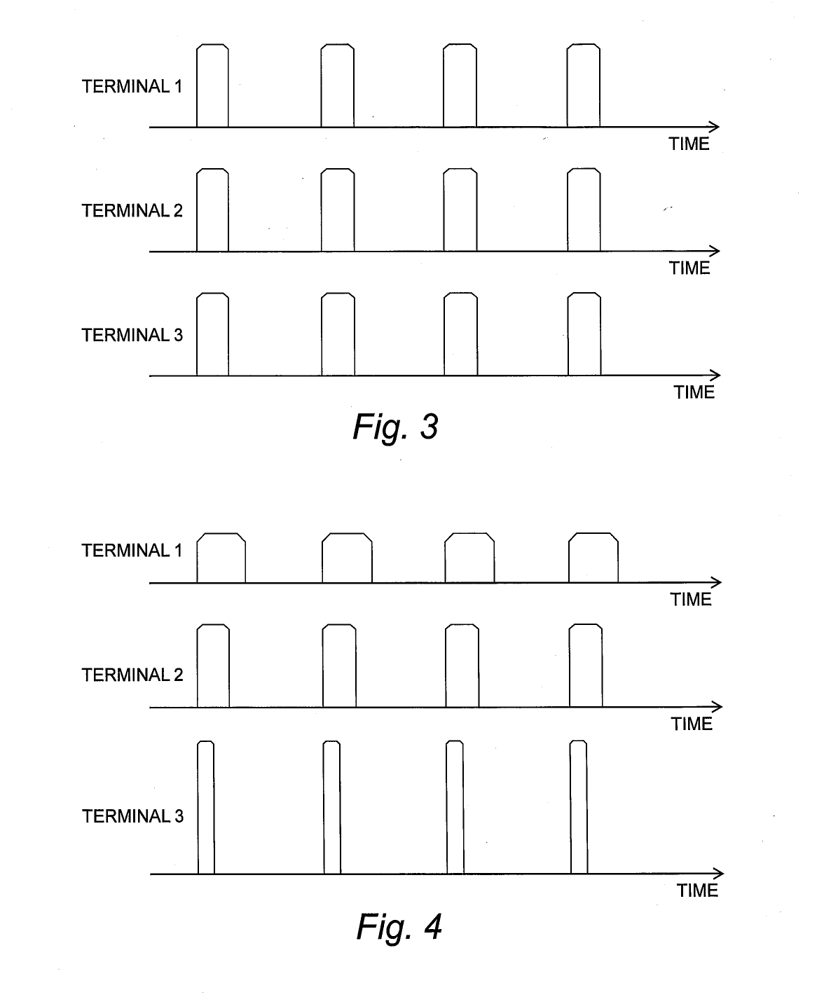

FIG. 3 is a diagram illustrating an example of a temporal distribution of events that each of the data post terminals transmits center data by using the wireless communication system.

As illustrated in FIG. 1, the data post terminals are arranged in various locations within the airport including the runways, and collect the information. The data collected by the data post terminals are consolidated into the center through the wireless communication system. At this time, the applications on the each of the data post terminals transmit the collected data to the center at a fixed time or on a regular basis. Therefore, as illustrated in FIG. 3, traffic necessary for a plurality of terminals to send the data to the center at the same timing occurs. Even if the each of the terminals use the wireless resources less frequently, when the wireless resources are simultaneously used by the plurality of terminals at a specific timing, there occurs a time slot in which a throughput is extremely high in a burst manner. At the time at which the throughput is high in a burst manner, a large amount of wireless resources are used, which affects the entire system including the mobility terminal.

States in which the wireless resources are occupied differ depending on conditions of propagation paths from the each of the data post terminals. FIG. 4 is a diagram illustrating an example of a temporal distribution of events that the each of the data post terminals being differ in distance from the base station transmits center data.

An output from the terminal is limited as standard, and hence a signal transmitted from the distant terminal reaches the base station after being greatly attenuated. Therefore, a signal-to-noise power ratio of a signal received by the base station differs between the close terminal and the distant terminal. Therefore, the distant terminal transmits a signal having a low modulation index. In other words, uplink throughputs allowed by the each of the terminals are uneven. On the other hand, it is estimated that an amount of data to be transmitted is substantially the same among the each of the terminals. This means that the time during which the terminal occupies the wireless resource in order to transmit a fixed amount of data differs depending on the terminals.

The vertical axis of FIG. 4 represents the uplink throughput of each terminal. The throughput differs among the terminals, and hence the time required by the each of the terminals to transmit the data differs. However, in this case, a start time for data transmission is controlled by the application, and hence a time slot in which the amount of transmission data is extremely large in a burst manner occurs in the time corresponding to the head part of the data transmission. In this manner, irrespective of the wireless communication system, traffic that affects the wireless communication system occurs in a specific time slot due to the characteristic of an upper application layer.

In the airport surface communication, a large number of carriers are provided as described above with reference to FIG. 2, but the terminal accesses an arbitrary carrier, and hence particularly the fixedly-arranged data post terminals may access a specific carrier in a concentrated manner. When a large number of data post terminals are allocated to a specific carrier, the wireless resources are tightened with the carrier at a specific time.

Normally, an application developed separately from a wireless communication system does not control the traffic appropriately in consideration of the state of the subordinate wireless communication system. Therefore, the wireless communication system needs to grasp the situations and perform control to prevent the traffic of the data post terminals from concentrating on the specific carrier, to thereby distribute the load. It is preferred that an appropriate number of data post terminals be allocated to each of a plurality of provided carriers. A handover procedure under the initiative of the base station is provided as standard as a method of changing, by each terminal, the allocation from the currently selected carrier to another carrier.

However, as described above, the terminal is roughly classified into two kinds. One is the mobility terminal, and the other is the data post terminal. In order to provide appropriate load balancing, it is desired to discriminate between the two kinds of terminals and reallocate only the data post terminals among the carriers.

As solving means therefor, it is conceivable to employ a method in which, for example, in the upper layer, terminal information is acquired from AAA serving as an authentication apparatus at a time of authentication, to recognize a type of the terminal and notify a wireless layer thereof. According to this method, a control apparatus such as a base station control apparatus needs to previously record an identifier such as an ID or a MAC address of the terminal as information on the data post terminal. The airport surface communication is a small system, and it is not appropriate that the airport surface communication is managed by staff with expertise. Further, a human resource for updating the recorded identifier is required as driven by an event such as replacement of the terminal due to a malfunction thereof or placement of a new terminal.

It is desired that management work be autonomously performed for a small wireless communication system that covers one airport.

### First Embodiment

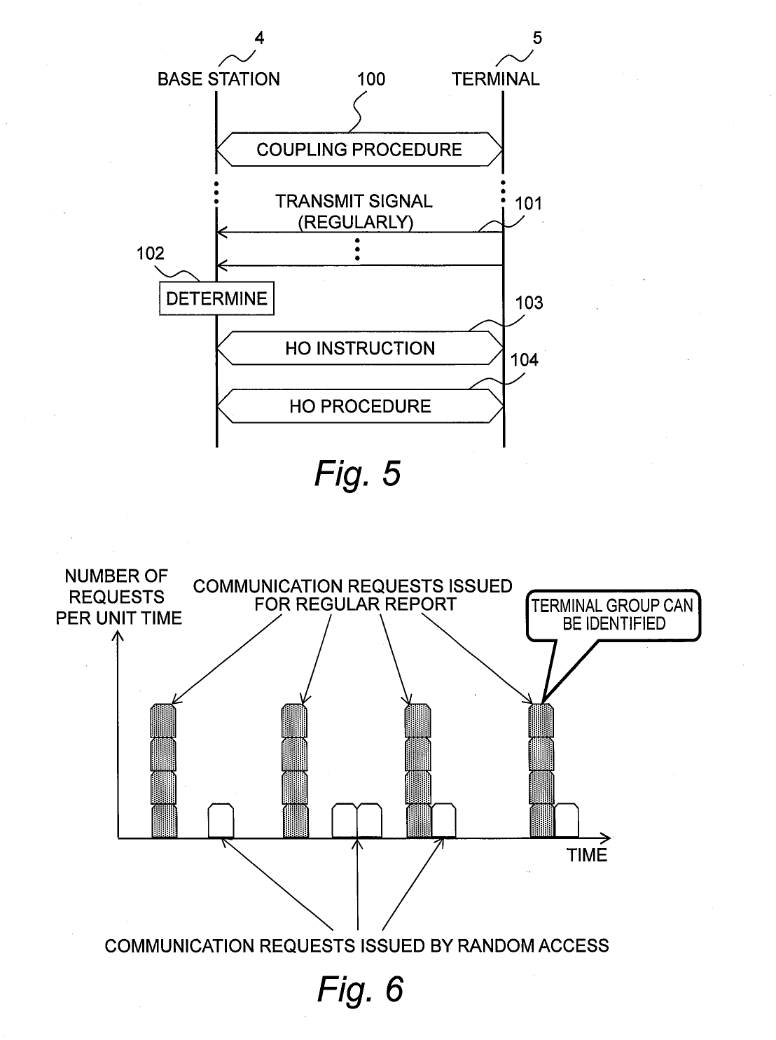

Next, a description is made of a first embodiment of this invention. First, with reference to FIG. 5, a description is made of steps from coupling of the terminal to a handover under the initiative of the base station. FIG. 5 is a sequence diagram illustrating general exchange of messages between the base station and the terminal according to this embodiment.

When power is turned on, the terminal observes carriers based on a preset order, and selects the most satisfactory carrier. Then, a coupling procedure (100) is performed in the selected carrier to couple to the base station.

After completing the coupling to the base station, the terminal is in a coupled state at all times. However, the wireless resources are managed by the base station, and when the terminal holds data to be transmitted, the terminal transmits a bandwidth request (BR) or a scheduling request (SR) for declaring to start using communication traffic. The terminal causes the communication traffic on a regular basis in response to a request received from the upper application. The terminal transmits a communication request including the BR or the SR to the base station to notify that there is data to be transmitted. The base station allocates the wireless resource in response to the communication request received from the terminal, and transmits the allocation information for the wireless resource to the terminal. The terminal transmits a signal by using a resource designated by the allocation information transmitted from the base station (101).

The base station according to this embodiment identifies the terminal that has transmitted the signal by a session ID, a MAC address, or the like of the terminal in response to the BR or the SR transmitted by the terminal. Further, the base station uses a timer to record a frequency of the BR or the SR that occurs during a predetermined time and the ID of the terminal. With this configuration, the terminals that have access at the same time during the above-mentioned predetermined time can be stored in a database as a group. Based on obtained statistics and the information on a terminal group, it is possible to determine a group of terminal groups that are coupling at the same time.

FIG. 6 is a diagram illustrating timings of the communication request issued in a case where the data post terminal and the mobility terminal coexist. In FIG. 6, the horizontal axis represents time, and the vertical axis represents the number of communication requests per unit time. Here, hatched portions indicate the number of communication requests issued by the data post terminal. The traffic of the data post terminals has such a characteristic of occurring at the same timing, which can be distinguished from the traffic of the mobility terminal that occurs at random.

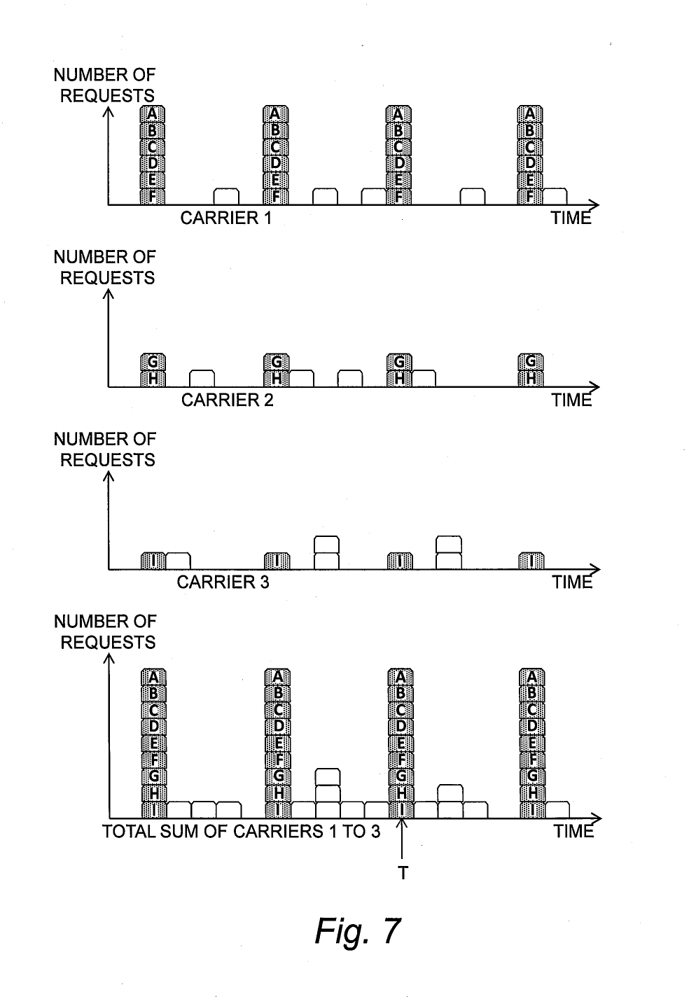

Then, the determined terminal group is summed up in a plurality of carriers. This allows the terminal group that requests communications at a specific time to be identified for each carrier, and as illustrated in FIG. 7, a distribution of the terminal groups for each carrier can be created. In FIG. 7, the horizontal axis represents time, and the vertical axis represents the number of communication requests per unit time. In addition, in a total number summed up in a plurality of carriers, a large number of communication requests are observed at a timing T, and the occurrence of the communication requests can be identified at the same timing.

At this time, the distribution of the communication requests is verified, and when, for example, a difference between in the number of data post terminals between a carrier 3 having a small number of data post terminals allocated thereto and a carrier 1 having a large number of data post terminals allocated thereto (five in the figure) is equal to or larger than a predetermined threshold value, scan information is acquired from the terminal allocated to the carrier 1 having a large number of terminals allocated thereto. The terminal allocated to the carrier 1 measures reception power of another carrier in accordance with a scan instruction issued by the base station, and reports to the base station. In this case, the base station refers to the report received from the terminal to select the terminal having a high reception power value of the carrier 3 as the terminal whose allocation to the carrier is to be changed (102). Then, a message for instructing to perform the handover under the initiative of the base station is transmitted to the selected terminal (103). The terminal performs the handover procedure for switching the carrier in accordance with the instruction (104).

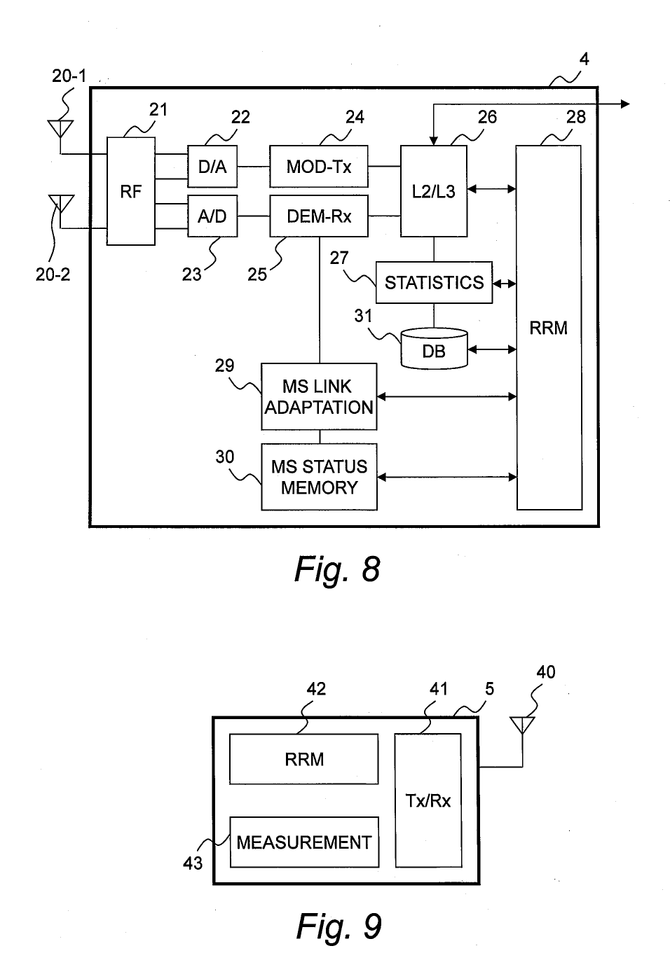

With reference to FIG. 8 and FIG. 9, a description is made of a configuration of a system including a base station apparatus 4 and a terminal 5 according to this embodiment. FIG. 8 is a configuration diagram illustrating the base station apparatus 4 according to this embodiment, and FIG. 9 is a configuration diagram illustrating the terminal 5 according to this embodiment.

The base station apparatus 4 includes two antennas 20-1 and 20-2. It should be noted that the number of antennas may differ from the one illustrated as an example. The antennas 20-1 and 20-2 are connected to an RF circuit 21. The RF circuit 21 converts radio signal received by the antennas 20-1 and 20-2 into a baseband signal. Further, the RF circuit 21 converts a signal to be transmitted from the antennas 20-1 and 20-2 from the baseband signal into an RF signal, and amplifies power of the RF signal to a desired level.

A transmitting end of the RF circuit 21 is connected to a D/A converter 22, and the D/A converter 22 converts a digital signal into an analog transmission signal. Further, a receiving end of the RF circuit 21 is connected to an A/D converter 23, and the A/D converter 23 converts an analog reception signal into a digital signal.

A transmission modem module 24 converts a signal generated by an L2/L3 module 26 into a modulation signal that can be transmitted wirelessly, and inputs the modulation signal to the D/A converter 22. Further, a reception modem module 25 extracts a pilot signal included in the reception signal, estimates the propagation path, detects/decodes a data signal, and retrieves the data transmitted to the base station apparatus 4. The state of the estimated propagation path is input to a terminal link adaptation module 29, and is used for mobility estimation. A status memory 30 stores estimated mobility. Further, the terminal 5 may estimate the mobility by using a fluctuation in condition of a downlink line for reporting to the base station apparatus 4 by use of a CQI channel or the like. It is clear that the case of using the CQI channel also falls into the scope of this invention because effects of this embodiment do not depend on a specific mobility estimation method.

The reception modem module 25 sends the received data to the L2/L3 module 26. The received data sent to the L2/L3 module 26 is split into user data and control data, and the user data is sent to a network, while the control data is sent to a radio management module (RRM) 28 to be used for wireless management. In particular, the information such as the ID of the terminal at the time of the coupling is recorded in a database module 31. The L2/L3 module 26 records the number of times of reception of the BR and the SR per unit time. A statistics processing module 27 counts such statistics. The RRM 28 determines whether or not a count value exceeds a threshold value, and when the count value exceeds the threshold value, identifies the ID of the terminal included in the received BR and SR to check consistency with the terminal group recorded in the database module 31.

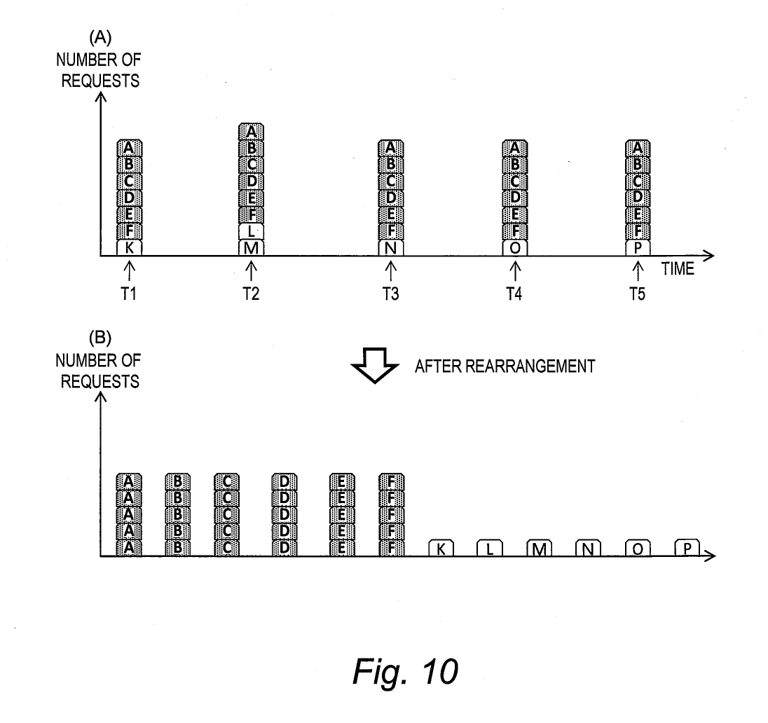

A method for the check is described with reference to FIGS. 10A and 10B. As illustrated in FIG. 10(A), the communication requests are summed up at timings T1, T2, T3, T4, and T5 at which a plurality of terminals 5 repeatedly transmit the communication request. It should be noted that in FIGS. 10(A) and (B), the alphabetical letters represents the IDs of the terminal 5.

FIG. 10(B) illustrates a summation result. Terminals A to F transmit the communication request at all the timings T1 to T5, and hence a high correlation is detected. On the other hand, the communication requests issued by terminals K to P are coincidentally detected at the timings T1 to T5, and therefore, when total sums at a plurality of timings are obtained, have a lower count than those of the terminals that synchronously issue traffic requests. Thus, by summing up the number of communication requests at a given specific timing, it is possible to identify the terminals (in other words, data post terminals) transmitting the communication request at the timings T1 to T5.

As illustrated in FIG. 9, the terminal 5 uses a radio module 41 to receive and transmit a signal input from an antenna 40. The radio module 41 extracts the received data and the control data from the reception signal. A radio management module (RRM) 42 uses the control data extracted by the radio module 41 to perform control processing. At a time of transmission, the radio module 41 subjects control data created by the RRM 42 to signal processing, and transmits the control data from the antenna 40 as radio transmission data. Further, the terminal 5 includes a signal measurement module 43 for measuring a signal obtained at a time of reception, and measures power of signals being transmitted by a plurality of base station apparatus 4.

Next, with reference to FIG. 7 and FIG. 8, a description is made of the load balancing performed when there is a deviation in the data post terminals allocated to the each of the carriers.

The RRM 28 identifies the data post terminals for each carrier, and calculates a difference (five in FIG. 7) in the number of data post terminals between the carrier 3 having the smallest number of data post terminals allocated thereto and the carrier 1 having the largest number of data post terminals allocated thereto. When the calculated difference is equal to or larger than a predetermined threshold value, the scan information is acquired from the terminals allocated to the carrier 1 having the largest number of terminals allocated thereto. The signal measurement module 43 of the terminal 5 measures the reception power of another carrier in accordance with the scan instruction issued from the base station apparatus 4, estimates a wireless state, and reports the measured value. In the case illustrated in FIG. 7, the RRM 28 selects the terminal having a high reception power value of the carrier 3 as the terminal whose allocation to the carrier is to be changed based on the report from the terminal 5.

Further, the RRM 28 creates a message for instructing to perform the handover under the initiative of the base station. The message created by the RRM 28 is sent through the L2/L3 module 26, the transmission modem module 24, the D/A converter 22, and the RF circuit 21 to be converted into a radio signal, and is transmitted from the antennas 20-1 and 20-2. The terminal 5 performs the handover to the corresponding carrier in accordance with the instruction issued from the base station apparatus 4. The control signal relating to the handover created by the RRM 42 of the terminal 5 is sent through the radio module 41, and is transmitted from the antenna 40.

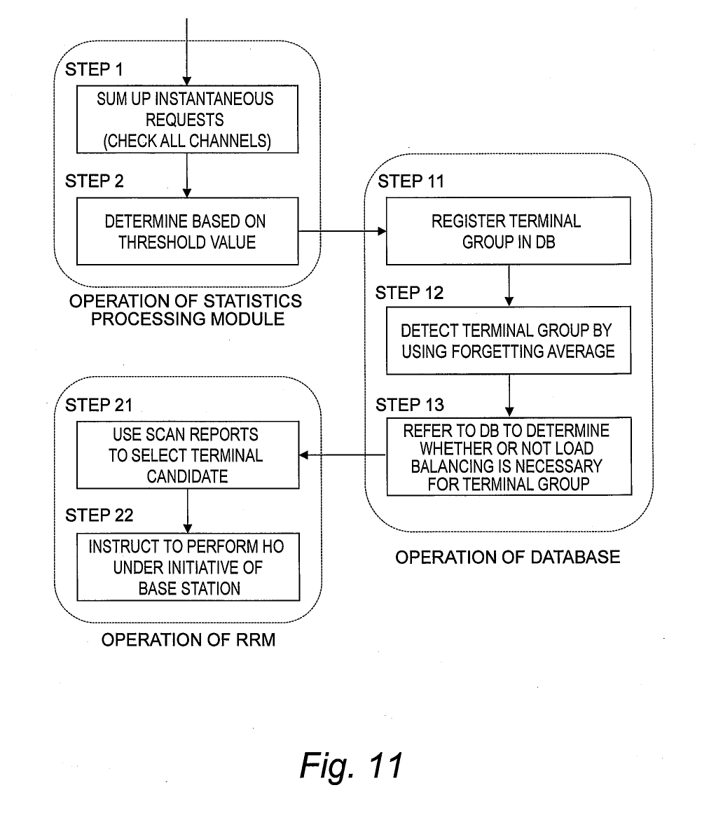

Next, with reference to FIG. 11, a description is made of the control processing executed by the statistics processing module 27, the RRM 28, and the database module 31 according to this embodiment.

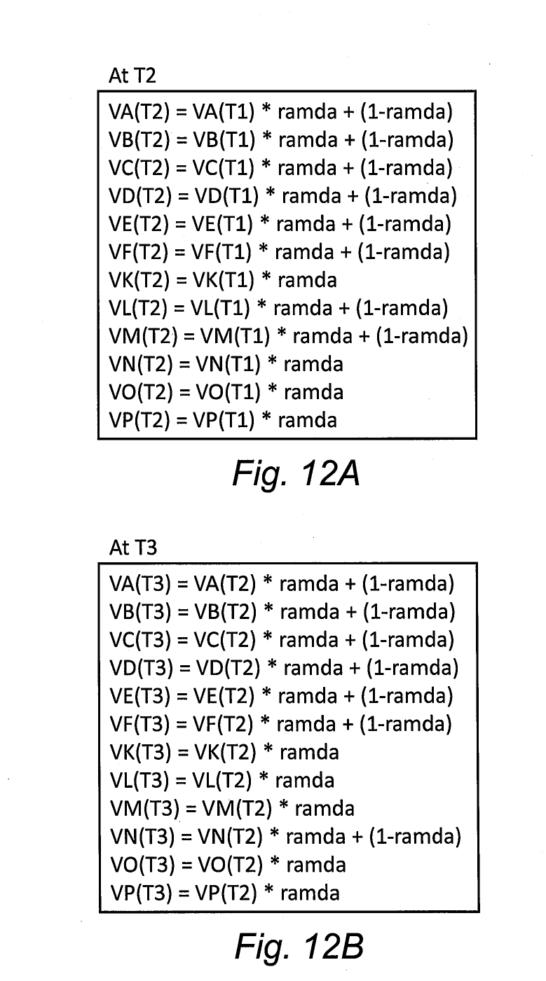

First, in Step 1, the statistics processing module 27 sums up the number of instantaneous communication requests per unit time for every carrier. With reference to FIG. 12A and FIG. 12B, an operation example thereof is described. In the operation example, in the same manner as in FIG. 10(A), traffic concentration from the data post terminals A to F occurs on a regular basis, and a large number of SRs or BRs occur at the timings T1, T2, T3, T4, and T5.

In Step 2 of FIG. 11, it is determined whether or not the obtained summation result is higher than a predetermined threshold value, and the timing at which the traffic is concentrated is extracted. When the summation result is higher than the predetermined threshold value, the procedure advances to Step 11 indicating an operation performed by the database module 31. In the example illustrated in FIG. 10(A), the threshold value is set so that the number of requests issued at the timing at which the traffic concentrates from the data post terminals A to F exceeds the threshold value.

When notified by the statistics processing module 27 that a large number of SRs and BRs per unit time have been detected, in Step 11 of FIG. 11, the database module 31 first registers the IDs of all the terminals involved in instantaneous traffic requests per unit time being currently issued. FIG. 12A and FIG. 12B illustrate examples of the information registered in the database module 31. As illustrated in FIG. 12A and FIG. 12B, at the each of the timings (T1, T2, T3, T4, and T5), the database module 31 records the IDs (A, B, C, D, E, F, G, H, I, J, K, L, M, N, O and P) of the terminals that transmitted the SR or the BR at the corresponding timing by being classified along with information of a frequency #1 (Freq#1). For example, the terminals that transmitted the SR or the BR at the timing T2 are the terminals A, B, C, D, E, F, L and M, and hence the database module 31 records the IDs of the corresponding terminals in a box of the corresponding timing as illustrated in FIG. 12A. In addition, in Step 12 of FIG. 11, the database module 31 is updated by using a forgetting average in regard to the registered terminals. Further, the IDs of the corresponding terminals are recorded in a box of another timing (for example, T3), and the database is updated by using the forgetting average as illustrated in FIG. 12B.

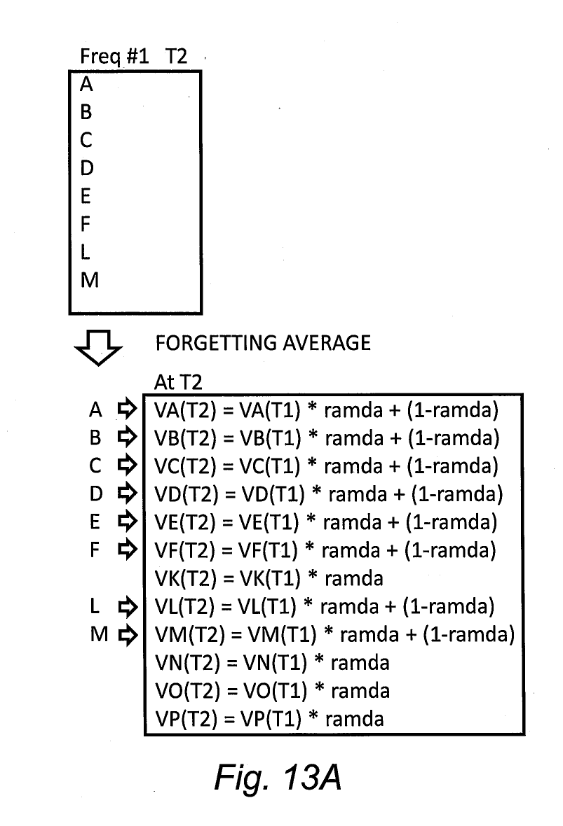

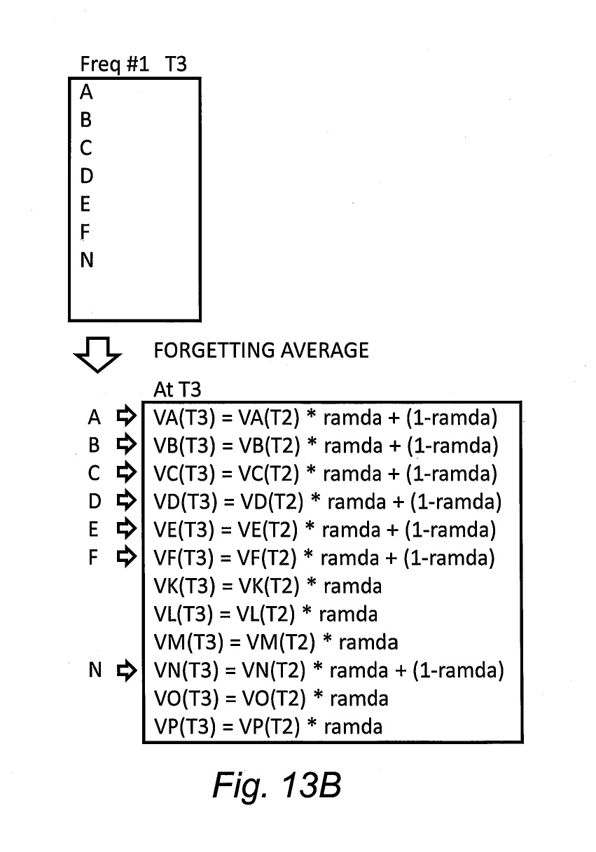

With reference to FIG. 13A and FIG. 13B, a description is made of the forgetting average (in other words, weighted average using a forgetting factor). FIG. 13A and FIG. 13B illustrate, in the upper portions thereof, the IDs of the terminals that transmitted the SR or the BR at the timings T2 and T3, respectively. Further, as illustrated in the lower portions of FIG. 13A and FIG. 13B, evaluation values Vx(Tn) corresponding to the terminals being currently coupled are recorded. As the evaluation value Vx(Tn) becomes higher, the more signals are transmitted at the same timing, and the evaluation value Vx(Tn) has a maximum value of 1. It is less likely that the terminal whose evaluation value Vx(Tn) is close to 0 is the data post terminal.

First, attention is focused on the timing T2 as illustrated in FIG. 13A. The terminals that transmitted the communication request at the timing T2 are eight terminals A, B, C, D, R, F, L, and M, and the evaluation values Vx(Tn) of all the terminals being currently coupled are evaluated. For example, in a case of evaluating twelve terminals A, B, C, D, R, F, K, L, M, N, O, and P, the term (1-ramda) is added to evaluation functions of the eight terminals A, B, C, D, R, F, L, and M detected at the timing T2, and an update is made so as to increase the evaluation functions. On the other hand, the term (1-ramda) is not added to evaluation functions of four terminals K, N, O, and P that were not detected at the timing T2, and hence an update is made so as to reduce values of the evaluation functions.

In the same manner, the term (1-ramda) is added to evaluation functions of seven terminals A, B, C, D, R, F, and N detected at the timing T3, and an update is made so as to increase the evaluation functions as illustrated in FIG. 13B. The term (1-ramda) is not added to evaluation functions of five terminals K, L, M, O, and P that were not detected at the timing T3, and hence an update is made so as to reduce values of the evaluation functions.

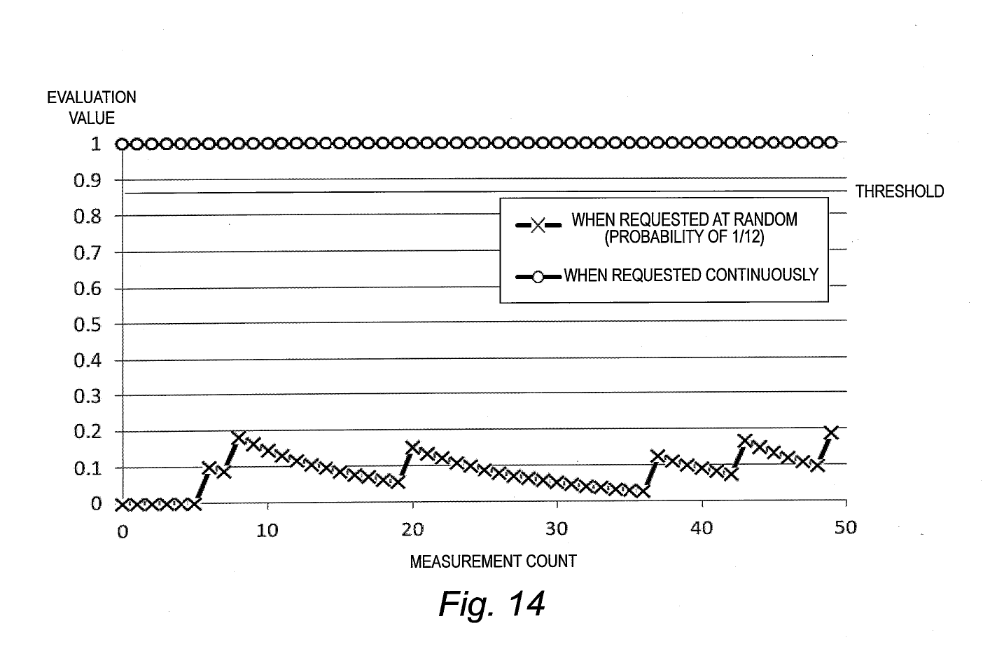

FIG. 14 is a diagram illustrating an example of the summation result obtained by repetitive processing of Step 12. The evaluation value does not fall below 1.0 for the terminal in which the SR or the BR is observed within the unit time more frequently than a threshold value at a predetermined timing. On the other hand, the evaluation value for the terminal in which the SR or the BR is observed incidentally rises at the observed timing, but is immediately subjected to the forgetting average to be lowered to approximately 0. The above-mentioned two different cases are distinguished by a threshold value. In other words, the terminal having the evaluation value that exceeds the predetermined threshold value can be determined to be the data post terminal.

In Step 13 of FIG. 11, with the database module 31 being referred to, the terminal having the evaluation value Vx(Tn) that exceeds the predetermined threshold value is extracted based on the result of the forgetting average. In addition, the distribution of the terminal groups is monitored for each carrier. When the number of terminals allocated to a specific carrier is larger than the number of terminals allocated to another carrier, it is determined that the load balancing is necessary, and the RRM 28 is requested to carry out the load balancing.

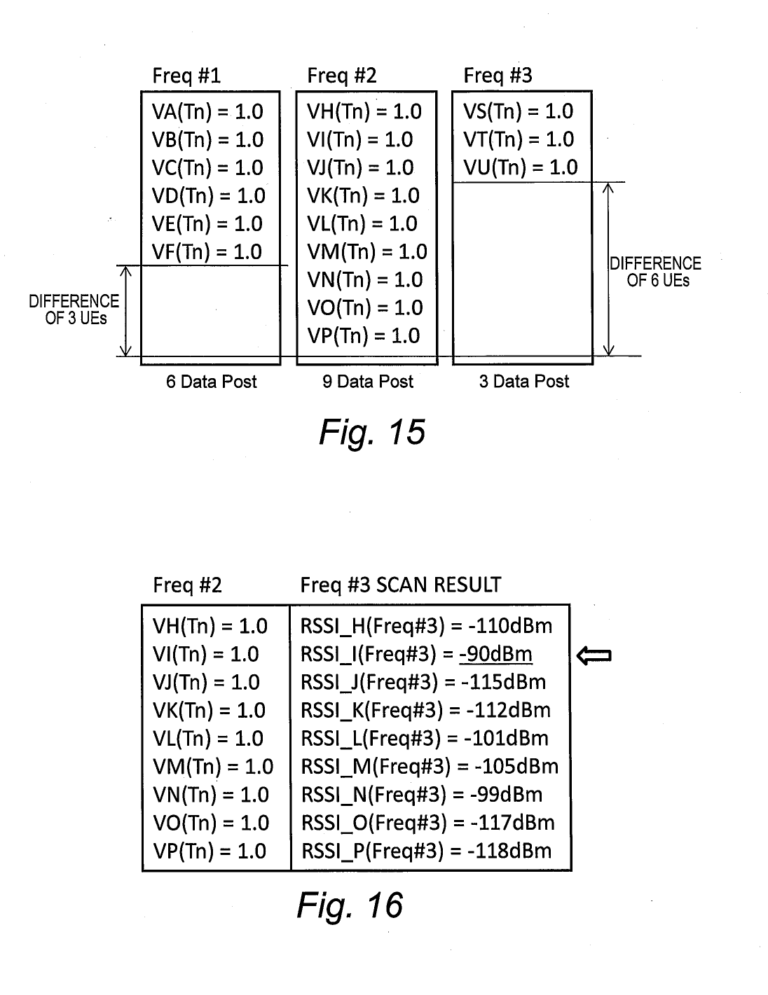

FIG. 15 is a diagram illustrating an example of the processing performed in Step 13. In FIG. 15, the terminals estimated as the data post terminals detected with three frequencies (Freq#1, Freq#2, and Freq#3) are listed. At this time, the number of terminals detected with Freq#2 is larger than the number of terminals detected with Freq#1 by 3 and larger than the number of terminals detected with Freq#3 by 6. A predetermined threshold value is defined in the load balancing, and the load balancing is determined to be carried out when a difference in the number of data post terminals between the each of the frequencies is equal to or larger than the threshold value. At this time, to maximize the effect, the load balancing is performed by performing the handover from Freq#2 to Freq#3.

When receiving an instruction for the load balancing from the database module 31, in Step 21 of FIG. 11, the RRM 28 uses scan reports received from the terminals allocated to the carrier having a large number of terminals to grasp wireless propagation conditions of the each of the terminals relating to the carrier of a migration destination, and determines the terminal to be handed over. At this time, the scan report may be received by instructing the terminal allocated to the carrier having a large number of terminals to measure the reception electric field strength (RSSI) of the base station close thereto. It is desired to select the terminal exhibiting satisfactory wireless propagation conditions of the frequency of the migration destination in the scan report.

FIG. 16 is a diagram illustrating an example of the processing performed in Step 21. In FIG. 16, the terminals allocated to Freq#2 are listed, and the RSSI of Freq#3 to be the migration destination based on the scan is summed up. Here, according to report values of the each of the terminals, the RSSI of the terminal whose ID is “I” is the highest value. In this manner, when the terminal is subjected to the handover, the terminal expected to exhibit satisfactory communications is selected, and the terminal to be subjected to the load balancing is selected.

In addition, in Step 22, the RRM 28 transmits a message for instructing to perform the handover under the initiative of the base station to the corresponding terminal I.

By the series of processing, the base station apparatus 4 can grasp the conditions in which the handover is to be performed, select the terminal whose channel needs to be shifted, and instruct the corresponding terminal to be subjected to the handover under the initiative of the base station.

The embodiment of this invention is described by taking the example of communications performed on the airport surface, but this invention can be applied to a wireless communication system for performing data communications on a regular basis, such as a smart meter or an M2M in which machines coupled to a computer network exchange information with each other without the intermediation of a human.

In addition, by applying this invention to a wireless network system including a wireless terminal (for example, smartphone) for transmitting data on a regular basis, it is possible to distribute the load corresponding to a specific channel, which can prevent a delay in the communications performed by another terminal.

As described above, according to the embodiment of this invention, it is possible to prevent congestion that occurs in a specific channel at a specific time.

Further, statistics processing that uses the weighted average using a forgetting factor is used to determine whether or not the traffic occurs at the same timing, which allows the data post terminal to be determined with accuracy.

Further, the terminal is handed over from the carrier having the largest number of terminals allocated thereto to the carrier having the smallest number of terminals allocated thereto, which allows the load balancing to be performed appropriately.

In addition, the scan reports received from the terminal are used to grasp the wireless propagation conditions of the each of the terminals relating to the carrier of the migration destination, and determines the terminal to be handed over, which allows the terminal exhibiting satisfactory wireless propagation conditions of the carrier of the migration destination to be selected.

This invention is not limited to the above-described embodiments but includes various modifications. The above-described embodiments are explained in details for better understanding of this invention and are not limited to those including all the configurations described above. A part of the configuration of one embodiment may be replaced with that of another embodiment; the configuration of one embodiment may be incorporated to the configuration of another embodiment. A part of the configuration of each embodiment may be added, deleted, or replaced by that of a different configuration.

The above-described configurations, functions, processing modules, and processing means, for all or a part of them, may be implemented by hardware: for example, by designing an integrated circuit. The above-described configurations and functions may be implemented by software, which means that a processor interprets and executes programs providing the functions.

The information of programs, tables, and files to implement the functions may be stored in a storage device such as a memory, a hard disk drive, or an SSD (Solid State Drive), or a storage medium such as an IC card, or an SD card.

The drawings illustrate control lines and information lines as considered necessary for explanation but do not show all control lines or information lines in the products. It can be considered that almost of all components are actually interconnected.

What is claimed is:

1. A wireless communication system, comprising:
a plurality of terminal apparatus; and
at least one base station apparatus,
each of the plurality of terminal apparatus and the at least one base station apparatus being configured to communicate to/from each other with any one of a plurality of carriers,
the at least one base station apparatus being configured to:
determine which of a first terminal apparatus having a characteristic of repeatedly transmitting a signal at the same timing and a second terminal apparatus having a characteristic of transmitting a signal at a random timing different from the same timing each of the plurality of terminal apparatus is;
monitor each of the plurality of carriers to which the first terminal apparatus is allocated; and
allocate a plurality of the first terminal apparatus to distribute to the plurality of carriers based on a result of the monitoring.

2. The wireless communication system according to claim 1, wherein the at least one base station apparatus is configured to:
repeatedly detect a signal transmission timing for each of the plurality of terminal apparatus; and
statistically process a result of the detecting by use of a weighted average using a forgetting factor, to thereby determine which of the first terminal apparatus and the second terminal apparatus the each of the plurality of terminal apparatus is.

3. The wireless communication system according to claim 1, wherein the at least one base station apparatus issues an instruction to migrate one of the plurality of terminal apparatus from one of the plurality of carriers having a largest number of terminal apparatus allocated thereto to one of the plurality of carriers having a smallest number of terminal apparatus allocated thereto.

4. The wireless communication system according to claim 1, wherein:
each of the plurality of terminal apparatus acquires a communication state of another one of the plurality of carriers than one of the plurality of carriers being used with respect to the at least one base station apparatus, and transmits the acquired communication state to the at least one base station apparatus; and
the at least one base station apparatus instructs one of the plurality of terminal apparatus under the satisfactory acquired communication state to migrate to the another one of the plurality of carriers.

5. A base station apparatus configured to communicate to/from a plurality of terminal apparatus with a plurality of carriers,
the base station apparatus being configured to:
determine which of a first terminal apparatus having a characteristic of repeatedly transmitting a signal at the same timing and a second terminal apparatus having a characteristic of transmitting a signal at a random timing different from the same timing each of the plurality of terminal apparatus is;
monitor each of the plurality of carriers to which the plurality of first terminal apparatus is allocated; and
allocate a plurality of the first terminal apparatus to distribute to the plurality of carriers based on a result of the monitoring.

6. The base station apparatus according to claim 5, wherein the base station apparatus is configured to:
repeatedly detect a signal transmission timing for each of the plurality of terminal apparatus; and
statistically process a result of the detecting by use of a weighted average using a forgetting factor, to thereby determine which of the first terminal apparatus and the second terminal apparatus the each of the plurality of terminal apparatus is.

7. The base station apparatus according to claim 5, wherein the base station apparatus issues an instruction to migrate one of the plurality of terminal apparatus from one of the plurality of carriers having a largest number of terminal apparatus allocated thereto to one of the plurality of carriers having a smallest number of terminal apparatus allocated thereto.

8. The base station apparatus according to claim 5, wherein:
each of the plurality of terminal apparatus acquires a communication state of another one of the plurality of carriers than one of the plurality of carriers being used with respect to the base station apparatus, and transmits the acquired communication state to the base station apparatus; and
the base station apparatus instructs one of the plurality of terminal apparatus under the satisfactory acquired communication state to migrate to the another one of the plurality of carriers.

9. A wireless communication method performed in a wireless communication system,
the wireless communication system including a plurality of terminal apparatus and at least one base station apparatus,
each of the plurality of terminal apparatus and the at least one base station apparatus being configured to communicate to/from each other with any one of a plurality of carriers,
the wireless communication method comprising steps of:
determining, by the at least one base station apparatus, which of a first terminal apparatus having a characteristic of repeatedly transmitting a signal at the same timing and a second terminal apparatus having a characteristic of transmitting a signal at a random timing different from the same timing each of the plurality of terminal apparatus is;
monitoring, by the at least one base station apparatus, each of the plurality of carriers to which the first terminal apparatus is allocated; and
allocating, by the at least one base station apparatus, a plurality of the first terminal apparatus to distribute to the plurality of carriers based on a result of the monitoring.

10. The wireless communication method according to claim 9, further comprising steps of:
repeatedly detecting, by the at least one base station apparatus, a signal transmission timing for each of the plurality of terminal apparatus; and
statistically processing, by the at least one base station apparatus, a result of the detecting by use of a weighted average using a forgetting factor, to thereby determine which of the first terminal apparatus and the second terminal apparatus the each of the plurality of terminal apparatus is.

11. The wireless communication method according to claim 9, further comprising a step of issuing, by the at least one base station apparatus, an instruction to migrate one of the plurality of terminal apparatus from one of the plurality of carriers having a largest number of terminal apparatus allocated thereto to one of the plurality of carriers having a smallest number of terminal apparatus allocated thereto.

12. The wireless communication method according to claim 9, further comprising:
acquiring, by each of the plurality of terminal apparatus, a communication state of another one of the plurality of carriers than one of the plurality of carriers being used with respect to the at least one base station apparatus, and transmitting the acquired communication state to the at least one base station apparatus; and
instructing, by the at least one base station apparatus, one of the plurality of terminal apparatus under the satisfactory acquired communication state to migrate to the another one of the plurality of carriers.
